(19) United States
(12) Patent Application Publication
(10) Pub. No.: US 2020/0383353 A1
(43) Pub. Date: Dec. 10, 2020

(54) SUPPLEMENT MATERIAL FOR USE IN PET FOOD

(71) Applicants: DSM IP ASSETS B.V., Heerlen (NL); EVONIK OPERATIONS GMBH, Essen (DE)

(72) Inventors: Jonathan W. WILSON, Kaiseraugst (CH); Shiguang YU, Kaiseraugst (CH)

(21) Appl. No.: 16/886,691

(22) Filed: May 28, 2020

Related U.S. Application Data
(63) Continuation of application No. 15/315,094, filed on Nov. 30, 2016, now abandoned.

(30) Foreign Application Priority Data
Oct. 1, 2015 (EP) 15187961.6
Dec. 17, 2015 (EP) 15200774.6

(51) Int. Cl. A23K 20/158; A23K 10/16; A23K 50/40

(52) U.S. Cl. CPC A23K 20/158; A23K 50/40; A23K 10/16

(57) ABSTRACT

Methods for sustainably producing a pet food product and the pet food products thereby produced include formulating a pet food product by replacing all or part of fish oil in a pet food product composition with a single microbial source of eicosapentaenoic acid (“EPA”) and docosahexaenoic acid (“DHA”). In a preferred embodiment, the microbial source comprising DHA and EPA derives from a microorganism/microbe of the genus Schizochytrium or Thraustochytrium.

### CROSS-REFERENCE TO RELATED APPLICATIONS

This application is a continuation of commonly owned copending U.S. Ser. No. 15/315,094, filed Nov. 30, 2016, (now abandoned), which is the U.S. national phase International Application No. PCT/EP2016/072576 filed Sep. 22, 2016, which designated the U.S. and claims priority to EP Patent Application No. 15187961.6 filed Oct. 1, 2015 and EP Patent Application No. 15200774.6 filed Dec. 17, 2015, the entire contents of each of which are hereby incorporated by reference.

### FIELD

This invention is in the field of pet nutrition. In a particular aspect, the invention pertains to a method of sustainably producing a pet food product that includes at least a reduced amount of fish oil or fish meal.

### BACKGROUND

All vertebrate species, including pets, have a dietary requirement for both omega-6 and omega-3 polyunsaturated fatty acids [“PUFAs”]. Eicosapentaenoic acid [“EPA”; cis-5,8,11,14,17-eicosapentaenoic acid; omega-3] and docosahexaenoic acid [“DHA”; cis-4, 7, 10, 13, 16, 19-docosahexaenoic acid; 22:6 omega-3] are required for regular growth, health, reproduction and bodily functions.

Marine fish oil and fish meal have traditionally been used as the sole dietary lipid source of DHA and EPA in commercial animal feed including pet food given their ready availability, competitive price and the abundance of essential fatty acids contained within this product.

Typically, pet food comprises fishmeal and/or fish oil derived from wild caught species of small pelagic pet (predominantly anchovy, jack mackerel, blue whiting, capelin, sandeel and menhaden).

Since annual fish oil production has not increased beyond 1.5 million tons per year, the rapidly growing global animal feeding industry cannot continue to rely on finite stocks of marine pelagic pet as a supply of fish oil. Thus, there is great urgency to find and implement sustainable alternatives to fish oil that can keep pace with the growing global demand for animal feed products, including pet food products.

Many organizations recognize the limitations noted above with respect to fish oil availability and sustainability in respect to animal feed production. For example, in the United States, the National Oceanic and Atmospheric Administration is partnering with the Department of Agriculture in an Alternative Pet foods Initiative to “ . . . identify alternative dietary ingredients that will reduce the amount of fishmeal and fish oil contained in aquaculture feed while maintaining the important human health benefits of farmed seafood”.

U.S. Pat. No. 7,932,077 suggests recombinantly engineered Yarrowia lipolytica may be a useful addition to most animal feed, including pet food, as means to provide necessary omega-3 and/or omega-6 PUFAs and based on its unique protein:lipid:carbohydrate composition, as well as unique complex carbohydrate profile (comprising an approximate 1:4:4.6 ratio of mannan:beta-glucans:chitin).

U.S. Pat. Appl. Pub. No. 2007/0226814 discloses fish feed formulations containing at least one biomass obtained from fermenting microorganisms wherein the biomass contains at least 20% DHA relative to the total fatty acid content. Preferred microorganisms used as sources for DHA are organisms belonging to the genus Stramenopiles.

### SUMMARY

In one embodiment, the invention concerns a method of producing a pet food product containing eicosapentaenoic acid (EPA) and docosahexaenoic acid (DHA), said method comprising the step of formulating the pet food product with an additive composition containing a single microbial source of eicosapentaenoic acid (“EPA”) and docosahexaenoic acid (“DHA”).

In another embodiment, the invention concerns a method of sustainably producing a pet food product, said method comprising the step of formulating a pet food product by replacing all or part of fish oil in the composition with a single microbial source of eicosapentaenoic acid (“EPA”) and docosahexaenoic acid (“DHA”).

In a preferred embodiment, the microbial source comprising DHA and EPA is produced using a process based on the natural abilities of native microbes of Schizochytrium species.

In a third embodiment, the invention concerns a feed additive composition for pet food products, said additive composition comprises a single microbial source of eicosapentaenoic acid (“EPA”) and docosahexaenoic acid (“DHA”).

In a fourth embodiment, the invention concerns a pet food product comprises a total amount of EPA and DHA derived from the microbial source that is at least about 0.04% measured as a weight percent of the pet food product.

In a fifth embodiment, the invention concerns a pet food product with a microbial additive composition containing EPA and DHA, wherein the microbial additive is obtained from one single microbe.

In a sixth embodiment, the invention concerns a method of sustainably producing a pet food product, said method comprising the step of formulating the pet food product by replacing all or part of fish oil in the composition with a single microbial source of eicosapentaenoic acid (“EPA”) and docosahexaenoic acid (“DHA”), wherein said microbe is a transgenic microbe genetically engineered for the production of polyunsaturated fatty acid containing microbial oil comprising EPA and DHA.

Preferably, the transgenic microbe is a microorganism of the order Thraustochytriales.

### BRIEF DESCRIPTION OF THE DRAWINGS

FIG. 1 is bar graph of DHA and EPA concentrations in dogs for the experiments conducted according to Example 9 below, and

FIG. 2 is bar graph of DHA and EPA concentrations in dogs for the experiments conducted according to Example 10 below.

### DETAILED DESCRIPTION

In this disclosure, a number of terms and abbreviations are used. The following definitions are provided:

“Polyunsaturated fatty acid(s)” is abbreviated as “PUFA(s)”.
“Triacylglycerols” are abbreviated as “TAGs”.
“Total fatty acids” are abbreviated as “TFAs”.
“Fatty acid methyl esters” are abbreviated as “FAMEs”.
“Dry cell weight” is abbreviated as “DCW”.

As used herein the term “invention” or “present invention” is intended to refer to all aspects and embodiments of the invention as described in the claims and specification herein and should not be read so as to be limited to any particular embodiment or aspect.

The terms “pet food product”, “pet food formulation” and “pet food composition” are used interchangeably herein. Pet food is most commonly produced in flake, dry or wet form.

“Eicosapentaenoic acid” [“EPA”] is the common name for eis-5, 8, 11,14, 17-eicosapentaenoic acid. This fatty acid is a 20:5 omega-3 fatty acid. The term EPA as used in the present disclosure will refer to the acid or derivatives of the acid (e.g., glycerides, esters, phospholipids, amides, lactones, salts or the like) unless specifically mentioned otherwise.

“Docosahexaenoic acid” [“DHA”] is the common name for eis-4, 7, 10, 13, 16, 19-docosahexaenoic acid. This fatty acid is a 22:6 omega-3 fatty acid. The term DHA as used in the present disclosure will refer to the acid or derivatives of the acid (e.g., glycerides, esters, phospholipids, amides, lactones, salts or the like) unless specifically mentioned otherwise.

As used herein the term “additive composition” refers to material derived from a microbial source which is provided in a form selected from the group consisting of: biomass, processed biomass, partially purified oil and purified oil, any of which is obtained from one single microbe.

As used herein the term “biomass” refers to microbial cellular material. Biomass may be produced naturally, or may be produced from the fermentation of a native host or a mutant strain or a recombinant production host. The biomass may be in the form of whole cells, whole cell-lysates, homogenized cells, partially hydrolyzed cellular material, and/or partially purified cellular material (e.g., microbially produced oil). The term “processed biomass” refers to biomass that has been subjected to additional processing such as drying, pasteurization, disruption, etc., each of which is discussed in greater detail below.

The term “lipids” refer to any fat-soluble (i.e., lipophilic), naturally occurring molecule. A general overview of lipids is provided in U.S. Pat. Appl. Pub. No. 2009-0093543-A1. The term “oil” refers to a lipid substance that is liquid at 25° C. and usually polyunsaturated.

The term “extracted oil” refers to oil that has been separated from cellular materials, such as the microorganism in which the oil was synthesized. Extracted oils are obtained through a wide variety of methods, the simplest of which involves physical means alone. For example, mechanical crushing using various press configurations (e.g., screw, expeller, piston, bead beaters, etc.) can separate oil from cellular materials. Alternatively, oil extraction can occur via treatment with various organic solvents (e.g., hexane), via enzymatic extraction, via osmotic shock, via ultrasonic extraction, via supercritical fluid extraction (e.g., CO₂ extraction), via saponification and via combinations of these methods. An extracted oil may be further purified or concentrated.

“Fish oil” refers to oil derived from the tissues of an oily fish. Examples of oily fish include, but are not limited to: menhaden, anchovy, herring, capelin, cod and the like. Fish oil is a typical component of pet food products.

“Vegetable oil” refers to any edible oil obtained from a plant. Typically plant oil is extracted from seed or grain of a plant.

The term “triacylglycerols” [“TAGs”] refers to neutral lipids composed of three fatty acyl residues esterified to a glycerol molecule.

TAGs can contain long chain PUFAs and saturated fatty acids, as well as shorter chain saturated and unsaturated fatty acids. “Neutral lipids” refer to those lipids commonly found in cells in lipid bodies as storage fats and are so called because at cellular pH, the lipids bear no charged groups. Generally, they are completely non-polar with no affinity for water. Neutral lipids generally refer to mono-, di-, and/or triesters of glycerol with fatty acids, also called monoacylglycerol, diacylglycerol or triacylglycerol, respectively, or collectively, acylglycerols.

A hydrolysis reaction must occur to release free fatty acids from acylglycerols.

The term “total fatty acids” [“TFAs”] herein refers to the sum of all cellular fatty acids that can be derivatized to fatty acid methyl esters [“FAMEs”] by the base transesterification method (as known in the art) in a given sample, which may be biomass or oil, for example. Thus, total fatty acids include fatty acids from neutral lipid fractions (including diacylglycerols, monoacylglycerols and TAGs) and from polar lipid fractions (including, e.g., the phosphatidylcholine and phosphatidylethanolamine fractions) but not free fatty acids.

The term “total lipid content” of cells is a measure of TFAs as a percent of the dry cell weight [“DeW”]’ although total lipid content can be approximated as a measure of FAMEs as a percent of the DeW [“FAMEs % DeW”]. Thus, total lipid content [“TFAs % DeW”] is equivalent to, e.g., milligrams of total fatty acids per 100 milligrams of DeW.

The concentration of a fatty acid in the total lipid is expressed herein as a weight percent of TFAs (% TFAs), e.g., milligrams of the given fatty acid per 100 milligrams of TFAs. Unless otherwise specifically stated in the disclosure herein, reference to the percent of a given fatty acid with respect to total lipids is equivalent to concentration of the fatty acid as % TFAs (e.g., % EPA of total lipids is equivalent to EPA % TFAs).

In some cases, it is useful to express the content of a given fatty acid(s) in a cell as its weight percent of the dry cell weight (% DCW). Thus, for example, eicosapentaenoic acid % DCW would be determined according to the following formula: (eicosapentaenoic acid % TFAs)*(TFAs % DCW)]/100. The content of a given fatty acid(s) in a cell as its weight percent of the dry cell weight (% DCW) can be approximated, however, as: (eicosapentaenoic acid % TFAs)*(FAMEs % DCW)]/100.

The terms “lipid profile” and “lipid composition” are interchangeable and refer to the amount of individual fatty acids contained in a particular lipid fraction, such as in the total lipid or the oil, wherein the amount is expressed as a weight percent of TFAs. The sum of each individual fatty acid present in the mixture should be 100.

The term “blended oil” refers to an oil that is obtained by admixing, or blending, the extracted oil described herein with any combination of, or individual, oil to obtain a desired composition. Thus, for example, types of oils from different microbes can be mixed together to obtain a desired PUFA composition. Alternatively, or additionally, the PUFA-containing oils disclosed herein can be blended with fish oil, vegetable oil or a mixture of both to obtain a desired composition.

The term “fatty acids” refers to long chain aliphatic acids (alkanoic acids) of varying chain lengths, from about C12 to C22, although both longer and shorter chain-length acids are known. The predominant chain lengths are between C16 and C22. The structure of a fatty acid is represented by a simple notation system of “X:Y”, where X is the total number of carbon [“C”] atoms in the particular fatty acid and Y is the number of double bonds. Additional details concerning the differentiation between “saturated fatty acids” versus “unsaturated fatty acids”, “monounsaturated fatty acids” versus “polyunsaturated fatty acids” [“PUFAs”], and “omega-6 fatty acids” [“00-6” or “n-6”] versus “omega-3 fatty acids” [“00-3” or “n-3”] are provided in U.S. Pat. No. 7,238,482, which is hereby incorporated herein by reference.

“Fish meal” refers to a protein source for pet food products. Fish meals are typically either produced from fishery wastes associated with the processing of fish for human consumption (e.g., salmon, tuna) or produced from specific pet (i.e., herring, menhaden) which are harvested solely for the purpose of producing fish meal.

The amount of EPA (as a percent of total fatty acids [“% TFAs”]) and DHA % TFAs provided in typical fish oils varies, as does the ratio of EPA to DHA. Typical values are summarized in Table 1, based on the work of Turchini, Torstensen and Ng (Reviews in Aquaculture 1:10-57 (2009)):

TABLE 1
Typical EPA and DHA Content in various fish oils

| Fish oil | EPA | DHA | EPA:DHA Ratio |
|---|---|---|---|
| Anchovy oil | 17% | 8.8% | 1.93 |
| Capelin oil | 4.6% | 3.0% | 1.53 |
| Menhaden oil | 11% | 9.1% | 1.21 |
| Herring oil | 8.4% | 4.9% | 1.71 |
| Cod liver oil | 11.2% | 12.6% | 0.89 |

Often, oil from fish that have lower EPA:DHA ratios is used in pet food products, due to the lower cost.

In the fourth aspect, the pet food product may comprise a total amount of EPA and DHA derived from a single microbial source that is at least about 0.04%, measured as weight percent of the pet food product. This amount (i.e., 0.04%) is typically an appropriate minimal concentration that is suitable to support the growth of a variety of pet animals.

The pet food products of the present invention comprise one source of DHA and EPA, wherein the ratio of EPA:DHA in the composition is 0.2:1 to 1:1, each measured as a weight percent of total fatty acids in the microbial source or in the pet food product.

Most processes to make an additive composition according to the invention will begin with a microbial fermentation, wherein a particular microorganism is cultured under conditions that permit growth of the microorganism and production of microbial oils comprising EPA and DHA. At an appropriate time, the microbial cells are harvested from the fermentation vessel. This microbial biomass may be mechanically processed using various means, such as dewatering, drying, mechanical disruption, pelletization, etc. Then, the biomass (or extracted oil therefrom) is used as feed additive in pet food (preferably as a substitute for at least a portion of the fish oil used in standard pet food products). The pet food is then fed to animals at least over a portion of their lifetime, such that EPA and DHA from the pet food accumulate in the animals.

Microbial additive compositions comprising EPA and DHA according to the present invention may be provided in a variety of forms for use in pet food products herein, wherein DHA and EPA are typically contained within microbial biomass or processed biomass, or within a partially purified oil form or a purified oil. In some cases, it will be most cost effective to incorporate microbial biomass or processed biomass into the animal feed composition. In other cases, it will be advantageous to incorporate microbial oil (in partial or purified form) into the animal feed composition, preferably into the pet food product.

The microorganism according to the present invention is an algae, fungi or yeast. Preferred microbes are Thraustochytrids which are microorganisms of the order Thraustochytriales. Thraustochytrids include members of the genus Schizochytrium and Thraustochytrium and have been recognized as an alternative source of omega-3 fatty acids, including DHA and EPA. See U.S. Pat. No. 5,130,242.

In a preferred embodiment the microorganism is a mutant strain of the species Schizochytrium. Schizochytrium strains are natural sources of PUFAs such as DHA and can be optimized by mutagenesis to be used as microbial source according to the present invention.

DHA and EPA producing Schizochytrium strains can be obtained by consecutive mutagenesis followed by suitable selection of mutant strains which demonstrate superior EPA and DHA production and a specific EPA:DHA ratio. Starting wild type strains include those on deposit with the various culture collections throughout the world, e.g. the ATCC and the Centraalbureau voor Schimmelcultures (CBS). Typically it is necessary to perform two or more consecutive rounds of mutagenesis to obtain desirable mutant strains.

Any chemical or nonchemical (e.g. ultraviolet (UV) radiation) agent capable of inducing genetic change to the yeast cell can be used as the mutagen. These agents can be used alone or in combination with one another, and the chemical agents can be used neat or with a solvent.

For example, a strain can be mutated and selected such that it produces EPA and DHA in amounts to be commercially viable and with a specific EPA:DHA ratio.

Alternately, the microbial source according the invention can be produced by microbes genetically transformed for the production of the PUFAs. Optionally the microorganism may be engineered for production of DHA and EPA by expressing appropriate heterologous genes encoding for example desaturases and elongases of either the delta-6 desaturase/delta-6 elongase pathway or the delta-9 elongase/delta-8 desaturase pathway in the host organism.

Heterologous genes in expression cassettes are typically integrated into the host cell genome. The particular gene(s) included within a particular expression cassette depend on the host organism, its PUFA profile and/or desaturase/elongase profile, the availability of substrate and the desired end product(s). A PUFA polyketide synthase [“PKS”] system that produces EPA, such as that found in e.g., Shewanella putrefaciens (U.S. Pat. No. 6,140,486), Shewanella olleyana (U.S. Pat. No. 7,217,856), Shewanella japonica (U.S. Pat. No. 7,217,856) and Vibrio marinus (U.S. Pat. No. 6,140,486), could also be introduced into a suitable DHA producing microbe to enable EPA and DHA production. Host organisms with other PKS systems that natively produce DHA could also be engineered to enable production of a suitable combination of the PUFAs to yield an EPA:DHA ratio of up to and greater than 2:1.

One skilled in the art is familiar with the considerations and techniques necessary to introduce one or more expression cassettes encoding appropriate enzymes for EPA and DHA biosynthesis into a microbial host organism of choice, and numerous teachings are provided in the literature to one of skill. Microbial oils comprising EPA and DHA from these genetically engineered organisms may also be suitable for use in pet food products herein, wherein the oil may be contained within the microbial biomass or processed biomass, or the oil may be partially purified or purified oil.

Typical species of microorganisms useful for the present invention are deposited under ATCC Accession No. PTA-10208, PTA-10209, PTA-10210, or PTA-10211, PTA-10212, PTA-10213, PTA-10214, PTA-10215.

In some embodiments, the invention is directed to an isolated microorganism having the characteristics of the species deposited under ATCC Accession No. PTA-10212 or a strain derived therefrom. The characteristics of the species deposited under ATCC Accession No. PTA-10212 can include its growth and phenotypic properties (examples of phenotypic properties include morphological and reproductive properties), its physical and chemical properties (such as dry weights and lipid profiles), its gene sequences, and combinations thereof, in which the characteristics distinguish the species over previously identified species. In some embodiments, the invention is directed to an isolated microorganism having the characteristics of the species deposited under ATCC Accession No. PTA-10212, wherein the characteristics include an 18s rRNA comprising the polynucleotide sequence of SEQ ID NO1 or a polynucleotide sequence having at least 94%, 95%, 96%, 97%, 98%, or 99% identity to SEQ ID NO1, the morphological and reproductive properties of the species deposited under ATCC Accession No. PTA-10212, and the fatty acid profiles of the species deposited under ATCC Accession No. PTA-10212.

In further embodiments, the mutant strain is a strain deposited under ATCC Accession No. PTA-10213, PTA-10214, or PTA-10215. The microorganisms associated with ATCC Accession Nos. PTA-10213, PTA-10214, and PTA-10215 were deposited under the Budapest Treaty on Jul. 14, 2009 at the American Type Culture Collection, Patent Depository, 10801 University Boulevard, Manassas, Va. 201 10-2209.

In some embodiments, the invention is directed to an isolated microorganism of the species deposited under ATCC Accession No. PTA-10208. The isolated microorganism associated with ATCC Accession No. PTA-10208 is also known herein as Schizochytrium sp. ATCC PTA-10208. The microorganism associated with ATCC Accession No. PTA-10208 was deposited under the Budapest Treaty on Jul. 14, 2009 at the American Type Culture Collection, Patent Depository, 10801 University Boulevard, Manassas, Va. 20110-2209.

In some embodiments, the invention is directed to a mutant strain of the microorganism deposited under ATCC Accession No. PTA-10208. In further embodiments, the mutant strain is a strain deposited under ATCC Accession No. PTA-10209, PTA-10210, or PTA-1021 1. The microorganisms associated with ATCC Accession Nos. PTA-10209, PTA-10210, and PTA-1021 1 were deposited under the Budapest Treaty on Sep. 25, 2009 at the American Type Culture Collection, Patent Depository, 10801 University Boulevard, Manassas, Va. 20110-2209.

A microbe according to the present invention may be cultured and grown in a fermentation medium under conditions whereby the PUFAs are produced by the microorganism. Typically, the microorganism is fed with a carbon and nitrogen source, along with a number of additional chemicals or substances that allow growth of the microorganism and/or production of EPA and DHA. The fermentation conditions will depend on the microorganism used and may be optimized for a high content of the desired PUFA(s) in the resulting biomass.

In general, media conditions may be optimized by modifying the type and amount of carbon source, the type and amount of nitrogen source, the carbon-to-nitrogen ratio, the amount of different mineral ions, the oxygen level, growth temperature, pH, length of the biomass production phase, length of the oil accumulation phase and the time and method of cell harvest.

When the desired amount of EPA and DHA has been produced by the microorganism(s), the fermentation medium may be treated to obtain microbial biomass comprising the PUFA(s). For example, the fermentation medium may be filtered or otherwise treated to remove at least part of the aqueous component. The fermentation medium and/or the microbial biomass may be further processed, for example the microbial biomass may be pasteurized or treated via other means to reduce the activity of endogenous microbial enzymes that can harm the microbial oil and/or PUFAs. The microbial biomass may be subjected to drying (e.g., to a desired water content) or a means of mechanical disruption (e.g., via physical means such as bead beaters, screw extrusion, etc. to provide greater accessibility to the cell contents), or a combination of these. The microbial biomass may be granulated or pelletized for ease of handling. Microbial biomass obtained from any of the means described above may be also used as a source of a partially purified or purified microbial oil form comprising EPA and DHA. This source of microbial oil may then be used as a preferred feed additive in pet food products.

A preferred example of a microbial oil according to the invention is an oil from Schizochytrium containing
at least 40% w/w DHA & EPA, preferably about 50% w/w DHA & EPA,
an EPA:DHA ratio of about 0.2:1 to 1:1, preferably 0.4:1 to 0.8:1, and
at least one antioxidant which is added to provide stability.

In the present method, pet food products comprising EPA and DHA from microbial source are sustainably produced. Based on the disclosure herein, it will be clear that renewable alternatives to fish oil can be utilized, as a means to sustainably produce pet food products.

Pet food products comprise micro and macro components.

Macro components with nutritional functions provide animals with protein and energy required for growth and performance. With respect to pet, the pet food product should ideally provide the pet with: 1) fats, which serve as a source of fatty acids for energy (especially for heart and skeletal muscles); and, 2) amino acids, which serve as building blocks of proteins. Fats also assist in vitamin absorption; for example, vitamins A, D, E and K are fat-soluble or can only be digested, absorbed, and transported in conjunction with fats. Carbohydrates, typically of plant origin (e.g., wheat, sunflower meal, corn gluten, soybean meal), are also often included in the pet food products, although carbohydrates are not a superior energy source for pet over protein or fat.

Fats are typically provided via incorporation of fish meals (which contain a minor amount of fish oil) and fish oils into the pet food products. Extracted oils that may be used in pet food products include fish oils (e.g., from the oily fish menhaden, anchovy, herring, capelin and cod liver), and vegetable oil (e.g., from soybeans, rapeseeds, sunflower seeds and flax seeds). Typically, fish oil is the preferred oil, because it contains the long chain omega-3 polyunsaturated fatty acids [“PUFAs”], EPA and DHA; in contrast, vegetable oils do not provide a source of EPA and/or DHA. These PUFAs are needed for growth and health of pets. A typical pet food product will comprise from about 15-30% of oil (e.g., fish, vegetable, etc.), measured as a weight percent of the pet food product.

Another major macro component is the protein source. The protein supplied in pet food products can be of plant or animal origin. For example, protein of animal origin can be from marine animals (e.g., pet meal, fish oil, pet protein, krill meal, mussel meal, shrimp peel, squid meal, squid oil, etc.) or land animals (e.g., blood meal, egg powder, liver meal, meat meal, meat and bone meal, silkworm, pupae meal, whey powder, etc.). Protein of plant origin can include soybean meal, corn gluten meal, wheat gluten, cottonseed meal, canola meal, sunflower meal, rice and the like.

The technical functions of macro components can be overlapping as, for example, wheat gluten may be used as a pelleting aid and for its protein content, which has a relatively high nutritional value. There can also be mentioned guar gum and wheat flour.

Micro components include additives such as vitamins, trace minerals, pet food antibiotics and other biologicals. Minerals used at levels of less than 100 mg/kg (100 ppm) are considered as micro minerals or trace minerals.

Micro components with nutritional functions are all biologicals and trace minerals. They are involved in biological processes and are needed for good health and high performance. There can be mentioned vitamins such as vitamins A, E, K3, D3, B1, B3, B6, B12, C, biotin, folic acid, panthothenic acid, nicotinic acid, choline chloride, inositol and para-amino-benzoic acid. There can be mentioned minerals such as salts of calcium, cobalt, copper, iron, magnesium, phosphorus, potassium, selenium and zinc. Other components may include, but are not limited to, antioxidants, beta-glucans, bile salt, cholesterol, enzymes, monosodium glutamate, carotenoids, etc.

The technical functions of micro ingredients are mainly related to pelleting, detoxifying, mold prevention, antioxidation, etc.

Typical components which provide the ingredients for a dog food composition, in addition to inventive Ingredients, comprise, e.g., chicken/beef/turkey, liver, broken pearl barley, ground corn, brute fat, whole dried egg, fowl protein hydrolyzate, vegetable oil, calcium carbonate, choline chloride, potassium chloride, iodinized salt, iron oxide, zinc oxide, copper sulfate, manganese oxide, sodium selenite, calcium iodate, provitamin D, vitamin B1, niacin, calcium panthothenate, pyridoxin hydrochloride, riboflavin, folic acid, vitamin B12.

Typical components which provide the ingredients for a cat food composition, in addition to inventive Ingredients, comprise beef, chicken meat, dried chicken liver, lamb meat, lamb liver, pork, turkey meat, turkey liver, poultry meal, fish meal, fowl protein hydrolysate, animal fats, plant oils, soy bean meal, pea bran, maize gluten, whole dry egg, ground corn, corn flour, rice, rice flour, dry sugar beet molasses, fructooligosaccharides, soluble fibers, plant gums, cellulose powder, clay, bakers yeast, iodized sodium chloride, calcium sulfate, sodium triphosphate, dicalcium phosphate, calcium carbonate, potassium chloride, choline chloride, magnesium oxide, zinc oxide, iron oxide, copper sulfate, iron sulfate, manganese oxide, calcium jodate, sodium selenite, provitamin D, thiamine, niacin, calcium pantothenate, pyridoxine hydrochloride, riboflavin, folic acid, vitamin B12, taurin, L-carnitine, caseine, D-methionine.

Wet pet food contains between about 70 and about 85% moisture and about 15 and about 25% dry matter.

A typical wet food for adult dogs may, e.g. comprise, in addition to the microbial source of DHA and EPA according to the invention, at minimum 24% protein, 15% fat, 52% starch, 0.8% fiber, 3% linolic acid, 0.6% calcium, 0.5% phosphorus, the Ca:P ratio being 1:1, 0.2% potassium, 0.6% sodium, 0.09% chloride, 0.09% magnesium, 170 mg/kg of iron, 15 mg/kg of copper, 70 mg/kg of manganese, 220 mg/kg of zinc, 4 mg/kg of iodine, 0.43 mg/kg of selenium, 74000 IU/kg of vitamin A, 1200 IU/kg of vitamin D, 11 mg/kg of vitamin B1, 6 mg/kg of riboflavin, 30 mg/kg of pantothenic acid, 20 mg/kg of niacin, 4.3 mg/kg of pyridoxine, 0.9 mg/kg of folic acid, 0.2 μg/kg of vitamin B12, 2500 mg/kg of choline, 2500 mg/kg cholin, all percentages being based on dry weight of the total food composition.

A typical wet food for adult cats may, e.g. comprise, in addition to the microbial source of DHA and EPA according to the invention, at minimum 44% protein, 25% fat, 20% starch, 2.5% fiber, 0.8% calcium, 0.6% phosphorus, 0.8% potassium, 0.3% sodium, 0.09% chloride, 0.08% magnesium, 0.25% taurin, 170 mg/kg of iron, 15 mg/kg of copper, 70 mg/kg of manganese, 220 mg/kg of zinc, 4 mg/kg of iodine, 0.43 mg/kg of selenium, 74000 IU/kg of vitamin A, 1200 IU/kg of vitamin D, 11 mg/kg of vitamin B1, 6 mg/kg of riboflavin, 30 mg/kg of pantothenic acid, 20 mg/kg of niacin, 4.3 mg/kg of pyridoxine, 0.9 mg/kg of folic acid, 0.2 μg/kg of vitamin B12, 2500 mg/kg of choline, 2500 mg/kg cholin, all percentages being based on dry weight of the total food composition.

Dry pet food contains between about 6 and about 14% moisture and about 86% or more dry matter.

A typical dry food for adult dogs may, e.g. comprise, in addition to the microbial source of DHA and EPA according to the invention, at minimum 25% protein, 12% fat, 41.5% starch, 2.5% fiber, 1% linolic acid, 1% calcium, 0.8% phosphorus, the Ca:P ratio being 1:1, 0.6% potassium, 0.35% sodium, 0.09% chloride, 0.1% magnesium, 170 mg/kg of iron, 35 mg/kg of copper, 70 mg/kg of manganese, 220 mg/kg of zinc, 4 mg/kg of iodine, 0.43 mg/kg of selenium, 15000 IU/kg of vitamin A, 1200 IU/kg of vitamin D, 11 mg/kg of vitamin B1, 6 mg/kg of riboflavin, 30 mg/kg of pantothenic acid, 20 mg/kg of niacin, 4.3 mg/kg of pyridoxine, 0.9 mg/kg of folic acid, 0.2 μg/kg of vitamin B12, 2500 mg/kg of choline, all percentages being based on dry weight of the total food composition.

A typical food for adult cats may, e.g. comprise, in addition to the microbial source of DHA and EPA according to the invention, at minimum 32% protein, 15% fat, 27.5% starch, 11% dietetic fibers, 4.5% fiber, 3.4% linolic acid, 0.08% arachionic acid, 0.15% taurin, 50 mg/kg L-carnitin, 5, 1% calcium, 0.8% phosphorus, the Ca:P ratio being at least 1:1, 0.6% potassium, 0.4% sodium, 0.6% chloride, 0.08% magnesium, 190 mg/kg of iron, 30 mg/kg of copper, 60 mg/kg of manganese, 205 mg/kg of zinc, 2.5 mg/kg of iodine, 0.2 mg/kg of selenium, 25000 IU/kg of vitamin A, 1500 IU/kg of vitamin D, 20 mg/kg of vitamin B1, 40 mg/kg of riboflavin, 56 mg/kg of pantothenic acid, 153 mg/kg of niacin, 14 mg/kg of pyridoxine, 3.2 mg/kg of folic acid, 0.2 mg/kg of vitamin B12, 3000 mg/kg of choline, all percentages being based on dry weight of the total food composition.

Dry food may be prepared, e.g., by screw extrusion including cooking, shaping and cutting of raw ingredients into a specific kibble shape and size in a very short period of time, while simultaneously destroying detrimental micro-organisms. The ingredients may be mixed into homogenous expandable dough and cooked in an extruder (steam/pressure) and forced through a plate under pressure and high heat. After cooking, the kibbles are then allowed to cool, before optionally being sprayed with a coating which may include liquid fat or digest including liquid or powdered hydrolyzed forms of an animal tissue such as liver or intestine from, e.g., chicken or rabbit. Hot air drying then reduces the total moisture content to 10% or less.

Canned (wet) food may be prepared, e.g., by blending the raw ingredients including meats and vegetables, gelling agents, gravies, vitamins, minerals and water. The mix is then fed into cans on a production line, the lids are sealed on and the filled cans are sterilized at a temperature of about 130° C. for about 50 to 100 min.

A typical formulation for a dog feed composition is shown in the following table.

| | |
|---|---|
| DHA | high 5.5 to moderate 1.9 to low 0.2 g/kg dry matter |
| EPA | high 5.0 to moderate 1.9 to low 0.2 g/kg dry matter |
| Vitamin E | 500 mg/kg diet |
| Vitamin C | 300 mg/kg diet |
| Beta-carotene | 50 mg/kg |
| Vitamin B₁ | 20 mg/kg |
| Vitamin B₆ | 14 mg/kg |
| Vitamin B₁₂ | 0.05 mg/kg |

Having generally described this invention, a further understanding can be obtained by reference to the examples provided herein. These examples are for purposes of illustration only and are not intended to be limiting.

### Example 1 Growth Characteristics of the Isolated Microorganism Deposited Under ATCC Accession No. PTA-10212

The isolated microorganism deposited under ATCC Accession No. PTA-10212 was examined for growth characteristics in individual fermentation runs, as described below. Typical media and cultivation conditions are shown in Table 3.

TABLE 3
PTA-10212 Vessel Media

| Ingredient | concentration | | ranges |
|---|---|---|---|
| Na₂S0₄ | g/L | 31.0 | 0-50, 15-45, or 25-35 |
| NaCl | g/L | 0.625 | 0-25, 0.1-10, or 0.5-5 |
| KCl | g/L | 1.0 | 0-5, 0.25-3, or 0.5-2 |
| MgS0₄*7H₂0 | g/L | 5.0 | 0-10, 2-8, or 3-6 |
| (NH₄)₂S0₄ | g/L | 0.44 | 0-10, 0.25-5, or 0.05-3 |
| MSG*1H20 | g/L | 6.0 | 0-10, 4-8, 01- 5-7 |
| CaCl₂ | g/L | 0.29 | 0.1-5, 0.15-3, or 0.2-1 |
| T 154 (yeast extract) | g/L | 6.0 | 0-20, 0.1-10, or 1-7 |
| KH₂PO₄ | g/L | 0.8 | 0.1-10, 0.5-5, or 0.6-1.8 |
| Post autoclave (Metals) | | | |
| Citric acid | mg/L | 3.5 | 0.1-5000, 10-3000, or 3-2500 |
| FeSO₄*7H₂O | mg/L | 10.30 | 0.1-100, 1-50, or 5-25 |
| MnCl₂*4H₂O | mg/L | 3.10 | 0.1-100, 1-50, or 2-25 |
| ZnS0₄*7H₂O | mg/L | 3.10 | 0.01-100, 1-50, or 2-25 |
| CoCl₂*6H₂O | mg/L | 0.04 | 0-1, 0.001-0.1, or 0.01-0.1 |
| Na₂MoO₄*2H₂O | mg/L | 0.04 | 0.001-1 , 0.005-0.5, or 0.01-0.1 |
| CuSO₄*5H₂O | mg/L | 2.07 | 0.1-100, 0.5-50, or 1 -25 |
| NiSO₄*6H₂O | mg/L | 2.07 | 0.1-100, 0.5-50, or 1-25 |
| Post autoclave (Vitamins) | | | |
| Thiamine | mg/L | 9.75 | 0.1-100, 1-50, or 5-25 |
| Vitamin B 12 | mg/L | 0.16 | 0.01-100, 0.05-5, or 0.1-1 |
| Ca[1/2]-pantothenate | mg/L | 2.06 | 0.1-100, 0.1-50, or 1-10 |
| Biotin | mg/L | 3.21 | 0.1- 100, 0.1-50, or 1 -10 |
| Post autoclave (Carbon) | | | |
| Glycerol | g/L | 30.0 | 5-150, 10-100, or 20-50 |
| Nitrogen Pet food: | | | |
| MSG*1H₂O | g/L | 17 | 0-150, 10-100, or 15-50 |

Typical cultivation conditions would include the following:
pH 6.5-9.5, about 6.5-about 8.0, or about 6.8-about 7.8;
temperature: 15-30 degrees Celsius, about 18-about 28 degrees Celsius, or about 21 to about 23 degrees Celsius;
dissolved oxygen: 0.1-about 100% saturation, about 5-about 50% saturation, or about 10-about 30% saturation; and/or
glycerol controlled @: 5-about 50 g/L, about 10-about 40 g/L, or about 15-about 35 g/L.

In carbon (glycerol) and nitrogen-fed cultures with 1000 ppm CI at 22.5° C. with 20% dissolved oxygen at pH 7.3, PTA-10212 produced a dry cell weight of 26.2 g/L after 138 hours of culture in a 10 L fermentor volume. The lipid yield was 7.9 g/L; the omega-3 yield was 5.3 g/L; the EPA yield was 3.3 g/L and the DHA yield was 1.8 g/L. The fatty acid content was 30.3% by weight; the EPA content was 41.4% of fatty acid methyl esters (FAME); and the DHA content was 26.2% of FAME. The lipid productivity was 1.38 g/L/day, and the omega-3 productivity was 0.92 g/L/day under these conditions, with 0.57 g/L/day EPA productivity and 0.31 g/L/day DHA productivity.

In carbon (glycerol) and nitrogen-fed cultures with 1000 ppm CI at 22.5° C. with 20% dissolved oxygen at pH 7.3, PTA-10212 produced a dry cell weight of 38.4 g/L after 189 hours of culture in a 10 L fermentor volume. The lipid yield was 18 g/L; the omega-3 yield was 12 g/L; the EPA yield was 5 g/L and the DHA yield was 6.8 g/L. The fatty acid content was 45% by weight; the EPA content was 27.8% of FAME; and the DHA content was 37.9% of FAME. The lipid productivity was 2.3 g/L/day, and the omega-3 productivity was 1.5 g/L/day under these conditions, with 0.63 g/L/day EPA productivity and 0.86 g/L/day DHA productivity.

In carbon (glycerol) and nitrogen-fed cultures with 1000 ppm CI at 22.5° C. with 20% dissolved oxygen at pH 6.8-7.7, PTA-10212 produced a dry cell weight of 13 g/L after 189 hours of culture in a 10 L fermentor volume. The lipid yield was 5.6 g/L; the omega-3 yield was 3.5 g/L; the EPA yield was 1.55 g/L and the DHA yield was 1.9 g/L. The fatty acid content was 38% by weight; the EPA content was 29.5% of FAME; and the DHA content was 36% of FAME. The lipid productivity was 0.67 g/L/day, and the omega-3 productivity was 0.4 g/L/day under these conditions, with 0.20 g/L/day EPA productivity and 0.24 g/L/day DHA productivity.

In carbon (glycerol) and nitrogen-fed cultures with 1000 ppm CI at 22.5-28.5° C. with 20% dissolved oxygen at pH 6.6-7.2, PTA-10212 produced a dry cell weight of 36.7 g/L-48.7 g/L after 191 hours of culture in a 10 L fermentor volume. The lipid yield was 15.2 g/L-25.3 g/L; the omega-3 yield was 9.3 g/L-13.8 g/L; the EPA yield was 2.5 g/L-3.3 g/L and the DHA yield was 5.8 g/L-11 g/L. The fatty acid content was 42.4%-53% by weight; the EPA content was 9.8%-22% of FAME; and the DHA content was 38.1%-43.6% of FAME. The lipid productivity was 1.9 g/L/day-3.2 g/L/day, and the omega-3 productivity was 1.2 g/L/day-1.7 g/L/day under these conditions, with 0.31 g/L/day-0.41 g/L/day EPA productivity and 0.72 g/L/day-1.4 g/L/day DHA productivity.

### Example 2

Experimental Data with DHA to be Added by Kuno

### Example 3

Commercial dry dog food (Hill's Science diet “Canine Maintenance dry” for dogs as supplied by Hill's Pet Nutrition GmbH, Liebigstrasse 2-20, D-22113) is sprayed/drugged with a microbial oil containing 45% w/w DHA & EPA with an EPA:DHA ratio of 0.4:1 to 0.8:1 in an amount sufficient to administer to a subject a daily dose of 4 mg to 120 mg total DHA&EPA per kg body weight. Further Vitamin C and E and β-carotene are incorporated in an amount sufficient to provide 30 mg vitamin C/kg, and 300 IU vitamin E/kg and 280 mg β-carotene/kg in the final food composition before extruding the entire blend. The food composition is dried to contain dry matter of about 90% by weight.

### Example 4

Commercial wet dog food (Hill's Science diet “Canine Maintenance wet” for dogs as supplied by Hill's Pet Nutrition GmbH, Liebigstrasse 2-20, 22113 Hamburg, Germany) is sprayed/drugged with the microbial oil of example 3 in an amount sufficient to administer to a subject a daily dose of 4 mg to 120 mg DHA &EPA per kg body weight. Further Vitamin C and E and β-carotene are incorporated in an amount sufficient to provide 30 mg vitamin C/kg, and 300 IU vitamin E/kg and 280 mg β-carotene/kg in the final food composition before cooking the entire blend. The food composition is dried to contain a dry matter of about 90% by weight.

### Example 5

Commercial dog treats (Mera Dog “Biscuit” for dogs as supplied by Mera Tiernahrung GmbH, Marienstrasse 80-84, 47625 Kevelaer-Wetten, Germany) are sprayed/drugged with the microbial oil of example 3 in an amount sufficient to administer to a subject a daily dose of 4 mg to 120 mg DHA&EPA per kg body weight. Further Vitamin C and E and β-carotene are incorporated in an amount sufficient to provide 30 mg vitamin C/kg, and 300 IU vitamin E/kg and 280 mg β-carotene/kg in the final food composition before extruding the entire blend. The food composition is dried to contain a dry matter of about 90% by weight.

### Example 6

Commercial dry cat food (Hill's Science diet “Feline Maintenance dry” for cats as supplied by Hill's Pet Nutrition GmbH, Liebigstrasse 2-20, D-22113) is sprayed/drugged with the microbial oil of example 3 in an amount sufficient to administer to a subject a daily dose of 4 mg to 120 mg DHA&EPA per kg body weight. Further Vitamin C and E and β-carotene are incorporated in an amount sufficient to provide 30 mg vitamin C/kg, and 300 IU vitamin E/kg and 280 mg β-carotene/kg in the final food composition before extruding the entire blend. The food composition is dried to contain a dry matter of about 90% by weight.

### Example 7

Commercial wet cat food (Hill's Science diet “Feline Maintenance wet” for cats as supplied by Hill's Pet Nutrition GmbH, Liebigstrasse 2-20, D-22113) is sprayed/drugged with the microbial oil of example 3 in an amount sufficient to administer to a subject a daily dose of 4 mg to 120 mg DHA&EPA per kg body weight. Further Vitamin C and E and β-carotene are incorporated in an amount sufficient to provide 30 mg vitamin C/kg, and 300 IU vitamin E/kg and 280 mg β-carotene/kg in the final food composition before cooking the entire blend. The food composition is dried to contain a dry matter of about 90% by weight.

### Example 8

Commercial cat treats (Whiskas Dentabits for cats as supplied by Whiskas, Masterfoods GmbH, Eitzer Str. 215, 27283 Verden/Aller, Germany) are sprayed/drugged with the microbial oil of example 3 n in an amount sufficient to administer to a subject a daily dose of 4 mg to 120 mg DHA&EPA per kg body weight. Further Vitamin C and E and β-carotene are incorporated in an amount sufficient to provide 30 mg vitamin C/kg, and 300 IU vitamin E/kg and 280 mg β-carotene/kg in the final food composition before extruding the entire blend. The food composition is dried to contain a dry matter of about 90% by weight.

### Example 9

### Algal Oil Rich in DHA and EPA Significantly Increases Plasma DHA and EPA Concentration in Dogs

### Objectives:

The objective of this study is to test if DHA and EPA in the algal oil product as described above is bioavailable in dogs.

### Study Design

Dogs: Thirty Beagle dogs, 14 male and 16 female and aged from 1-11 years, were used.

Diets: A dry extruded dog food was used as a control diet. It was formulated to meet the AAFCO Dog Food Nutrient Profiles for growth and reproduction. Two test diets were made by ennobling the dry kibbles of the control diet with 1.7% (Test Diet 1) or 5.1% (Test Diet 2) of the algal oil (DSM; Batch Number: VY00010672; Product Code: 5015816) at the expense of chicken fat in the control diet. Analyzed DHA and EPA concentration in the control and test diets are shown in Table 4.

TABLE 4
Dietary DHA and
EPA-Concentration

| | DHA | EPA | Moisture |
|---|---|---|---|
| Diets | % | % | % |
| Control | 0.11 | 0.02 | 7.8 |
| Test 1 | 0.70 | 0.38 | 7.7 |
| Test 2 | 1.80 | 1.03 | 7.9 |

### Procedures:

After Dogs were Given the Control Diet for 28 Days, they were Stratified into three groups based on gender and age, 10 dogs per group, and were given one of the experimental diets, the control, test 1, or test 2, for additional 28 days. Food intake was measured daily and body weight weekly. Blood samples were collected via jugular venipuncture on days 28, 42, and 56 for plasma DHA and EPA measurement. A veterinarian evaluated the skin and hair of dogs given the test diet 2 for any abnormalities on days 28 and 56. Fresh tap water was always available to dogs during the study.

### Results:

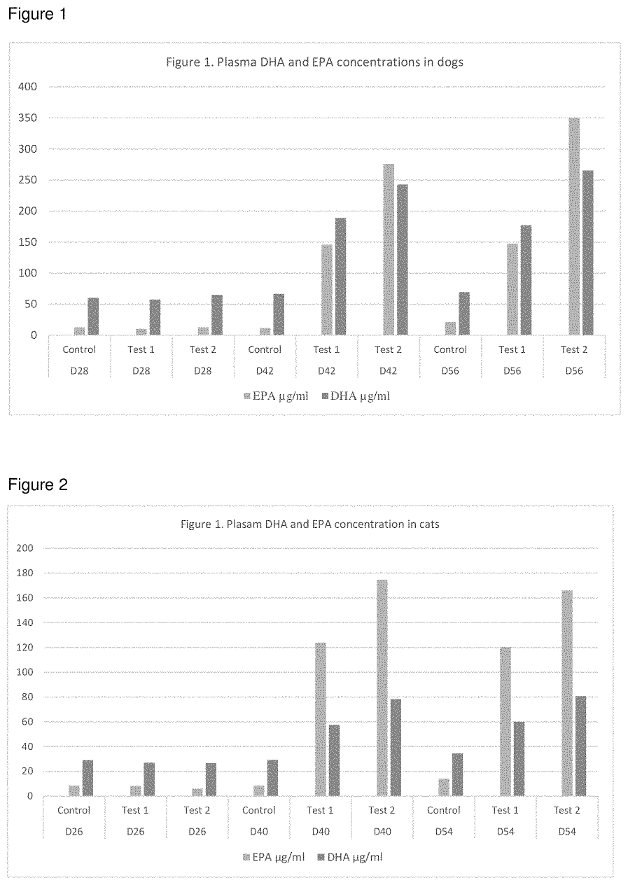

Plasma DHA and EPA concentrations were significantly increased in dogs fed the test diet 1 or 2 in a dose-response manner (p<0.05; FIG. 1). Food intake and body weight change were similar among the groups during the study. No adverse effect on skin and hair was observed in dogs fed the test diet 2.

### Conclusion:

The algal oil rich in DHA and EPA significantly increases plasma DHA and EPA concentration in dogs. DHA and EPA in the algal oil is bioavailable in dogs.

### Example 10

### Algal Oil Rich in DHA and EPA Significantly Increases Plasma DHA and EPA Concentration in Cats

### Objectives:

The objective of this study is to test if DHA and EPA in the algal oil product as described above is bioavailable in cats.

### Study Design

Cats: Thirty domestic long or short hair cats, 5 male and 25 female and aged from 2-12 years, were used.

Diets: A dry extruded cat food was used as a control diet. It was formulated to meet the AAFCO Cat Food Nutrient Profiles for growth and reproduction. Two test diets were made by ennobling the dry kibbles of the control diet with 1.7% (Test Diet 1) or 5.1% (Test Diet 2) of the algal oil (DSM; Batch Number: VY00010672; Product Code: 5015816) at the expense of chicken fat in the control diet. Analyzed DHA and EPA concentration in the control and test diets are shown in Table 5.

TABLE 5
Dietary DHA and EPA
Concentration

| | DHA | EPA | Moisture |
|---|---|---|---|
| Diets | % | % | % |
| Control | 0.12 | 0.04 | 5.8 |
| Test 1 | 0.69 | 0.37 | 6.1 |
| Test 2 | 1.88 | 1.08 | 5.8 |

Procedures:

After cats were given the control diet for 26 days, they were stratified into three groups based on gender and age, 10 cats per group, and were given one of the experimental diets, the control, test 1, or test 2, for additional 28 days. Food intake was measured daily and body weight weekly. Blood samples were collected via jugular venipuncture on days 26, 40, and 54 for plasma DHA and EPA measurement. A veterinarian evaluated the skin and hair of cats given the test diet 2 for any abnormalities on days 26 and 54. Fresh tap water was always available to cats during the study.

Results:

Plasma DHA and EPA concentrations were significantly increased in cats fed the test diet 1 or 2 in a dose-response manner (p<0.05; FIG. 2). Food intake and body weight change were similar among the groups during the study. No adverse effect on skin and hair was observed in cats fed the test diet 2.

Conclusion:

The algal oil rich in DHA and EPA significantly increases plasma DHA and EPA concentration in cats. DHA and EPA in the algal oil is bioavailable in cats.

1. A method of producing a pet food product or composition containing eicosapentaenoic acid (EPA) and docosahexaenoic acid (DHA), wherein the method comprises:
(a) providing pet food ingredients in need of supplementation; and
(b) forming the pet food product by adding to the pet food ingredients in need of supplementation an additive composition of a single microbial source of of the EPA and DHA such that a total amount of the EPA and DHA in the pet food product is at least about 0.04 wt. % based on weight of the pet food product, and at ratio of EPA concentration to DHA concentration of at least 0.2:1 based on individual concentrations of the EPA and DHA in the pet food product.

2. The method according to claim 1, wherein the method comprises the step of formulating the pet food product by incorporating into the pet food product the additive composition of the single microbial source of the EPA and DHA in a sufficient amount such that the pet food product is substantially free of fish oil.

3. The method of claim 1, wherein the additive composition is provided in a form selected from the group consisting of biomass, processed biomass, partially purified oil and purified oil, any of which is obtained from the microbial source.

4. The method of claim 1, wherein the microorganism from which the microbial source derives is an algae, fungi or yeast.

5. The method of claim 4, wherein the microorganism is a member of the genus Schizochytrium or Thraustochytrium.

6. The method of claim 5, wherein the microorganism has the characteristics of the species deposited under ATCC Accession No. PTA-10208 or PTA-10209 or PTA-10210 or PTA-10211 or PTA-10212 or PTA-10213 or PTA-10214 or PTA-10215.

7. The method of claim 4, wherein the microorganism is a mutant strain.

8. The method of claim 4, wherein the microorganism is a transgenic microbe genetically engineered for the production of polyunsaturated fatty acid containing microbial oil comprising EPA and DHA.

9. A feed additive composition for a pet food product comprising eicosapentaenoic acid (EPA) and docosahexaenoic acid (DHA) derived from a single microbial source, wherein the EPA and DHA are present in an amount such that a total amount of the EPA and DHA in the pet food product is at least about 0.04 wt. % based on weight of the pet food product, and at ratio of EPA concentration to DHA concentration of at least 0.2:1 based on individual concentrations of the EPA and DHA in the pet food product.

10. The additive composition of claim 9, which is provided in a form selected from the group consisting of biomass, processed biomass, partially purified oil and purified oil, any of which is obtained from the microbial source.

11. The additive composition of claim 9, wherein the microorganism from which the microbial source derives is an algae, fungi or yeast.

12. The additive composition of claim 11, wherein the microorganism is a member of the genus Schizochytrium or Thraustochytrium.

13. The additive composition of claim 12, wherein the microorganism has the characteristics of the species deposited under ATCC Accession No. PTA-10208 or PTA-10209 or PTA-10210 or PTA-10211 or PTA-10212 or PTA-10213 or PTA-10214 or PTA-10215.

14. The additive composition of claim 9, which is a purified microbial oil form containing at least 40% w/w of the DHA and EPA.

15. A pet food product comprising a single microbial source of eicosapentaenoic acid (EPA) and docosahexaenoic acid (DHA) derived from a single microbial source, wherein the EPA and DHA are present in an amount such that a total amount of the EPA and DHA in the pet food product is at least about 0.04 wt. % based on weight of the pet food product, and at ratio of EPA concentration to DHA concentration of at least 0.2:1 based on individual concentrations of the EPA and DHA in the pet food product.

16. The pet food product of claim 15, wherein the microbial source is a microbial oil and wherein the microbial oil is provided in a form selected from the group consisting of biomass, processed biomass, partially purified oil and purified oil, any of which is obtained from the microbial source.

17. The pet food product of claim 15, wherein the microorganism from which the microbial source derives is an algae, fungi or yeast.

18. The pet food product of claim 17, wherein the microorganism is a member of the genus Schizochytrium or Thraustochytrium.

19. The pet food product of claim 18, wherein the microorganism has the characteristics of the species deposited under ATCC Accession No. PTA-10208 or PTA-10209 or PTA-10210 or PTA-10211 or PTA-10212 or PTA-10213 or PTA-10214 or PTA-10215.
